(19) United States
(12) Patent Application Publication
(10) Pub. No.: US 2007/0126555 A1
(43) Pub. Date: Jun. 7, 2007

(54) Method and system for optimizing radio frequency identification (RFID) reader operation

(75) Inventor: William R. Bandy, Gambrills, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/294,418

(22) Filed: Dec. 6, 2005

(51) Int. Cl. H04Q 5/22

(52) U.S. Cl. 340/10.2; 370/458

(57) ABSTRACT

Methods and apparatuses are described for optimizing an interrogation of a radio frequency identification (RFID) tag population. An RFID reader sets an initial number of time slots used to interrogate a population of tags. The reader does not previously know the size of the tag population. The reader monitors responses of tags for one or more time slots of an interrogation round to collect statistical data, estimates a number of tags in the population based on the statistical data, and determines a new number of time slots based on the estimated number of tags. The reader adjusts the number of time slots accordingly for a subsequent interrogation round. The reader may repeat this process as needed to converge closer to the actual number of tags in the population, and an acceptable number of time slots, to enhance an efficiency of the process of interrogating the tag population.

### BACKGROUND OF THE INVENTION

1. Field of the Invention

The present invention generally relates to radio frequency identification (RFID) and more specifically relates to an RFID reader.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond. Each tag can store a unique identification number. The tags respond to the reader transmitted read signals by providing their identification number, so that they can be identified.

According to one example communications protocol, tags in a population respond to the reader during one of a multitude of time slots in a read cycle. Each tag is designated to respond to the reader during a particular time slot. The number of time slots available may be greater than or less than the number of tags in the population. If there is a large disparity between the number of tags in a population and the number of available time slots, the detection and/or monitoring of the tags can be inefficient by spending unproductive time waiting for either a time slot to expire with no tag response, or not capturing tag signals due to a multi-tag contention or “collision” for a transmission time slot to the reader. Therefore, what is needed is a method and apparatus for obtaining data from RFID tags in an efficient manner, reducing the number of empty and contended time slots.

### BRIEF SUMMARY OF THE INVENTION

Embodiments of the present invention provide methods and apparatuses for obtaining data from RFID tags in an efficient manner.

In accordance with an embodiment of the present invention there is a method in a RFID reader for adjusting a number of time slots. A RFID reader sets a first number of time slots in a tag inventory round, monitors time slots in a round for responses from tags and collects statistical data based on the tag responses. The RFID reader estimates a number of tags based on the statistical data, and sets a new number of time slots in a round based on the estimated number of tags.

In accordance with another embodiment of the present invention, there is provided a RFID reader. The RFID reader includes a RFID controller, a transceiver coupled to the RFID controller and at least one RF antenna coupled to the transceiver. The RF antenna transmits commands received from the RFID controller via the transceiver, and receives responses from a population of RFID tags in an environment. The RFID controller is configured to collect statistical RFID tag response data. The RFID controller estimates a number of tags in the environment based on the statistical RFID tag response data. The RFID controller adjusts a number of time slots in a round based on the estimated number of tags.

These and other advantages and features will become readily apparent in view of the following detailed description of the invention. Note that the Summary and Abstract sections may set forth one or more, but not all exemplary embodiments of the present invention as contemplated by the inventor.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags in accordance with an embodiment of the present invention.

FIG. 2 is a timing diagram illustrating a manner in which an RFID tag can respond to an interrogation by a reader in any of a plurality of equal length time slots.

FIG. 3 is a timing diagram illustrating a manner in which a reader adjusts a duration of a time slot during an interrogation of an RFID tag population.

FIG. 4 shows a plan view of an example RFID tag.

FIG. 5 is a block diagram of example processor logic included on a RFID tag.

FIGS. 6A and 6B depict block diagrams illustrating timing of communication signals sent between a reader and a RFID tag.

FIG. 7 is a block diagram of an example RFID reader, according to an embodiment of the invention.

FIG. 8 is a block diagram of an RFID controller, according to an embodiment of the invention.

FIG. 9 is a graph of probabilities of empty, contended and single response time slots vs. number of tags for a fixed number of slots.

FIG. 10 is an example flowchart showing steps performed by a RFID reader in accordance with an embodiment of the present invention.

FIG. 11 is an example flowchart illustrating steps performed by an RFID reader to collect statistics.

FIG. 12 is another example flowchart illustrating steps taken by an RFID reader to collect statistics.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to the obtaining of data from radio frequency identification (RFID) tags in an efficient manner. As is described in more detail herein, in accordance with an embodiment of the present invention, an RFID reader is configured to adjust the number of time slots based on statistical data collected by the reader. The RFID reader collects statistics by monitoring tag responses for a select number of time slots. Based on the statistical data, the reader can estimate the number of tags in the population and adjust the number of time slots accordingly. The reader continues to monitor the tag population and adjusts the number of time slots until it is optimal or within an acceptable range. The reader also adjusts the number of time slots for the number or tags that have been read and the number of tags entering and leaving the population. Although embodiments of the invention are directed towards RFID readers and the slotted ALOHA protocol, it is in no way limited these. For example embodiments of the invention are applicable to other devices that use allotted time slots for transmission and to other slotted communication protocols.

Example ways of estimating the size of a tag population from obtained statistics are provided below for purposes of illustration, and are not intended to be limiting. Further ways of estimating the size the a tag population are also within the scope of the present invention. Such further ways of estimating the size of the tag population may become apparent to persons skilled in the relevant art(s) from the teachings herein. Embodiments of the invention may be performed in hardware, software, firmware or any combination thereof.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Terminology

Gen-2 Terminology

The terms described below are described in the “EPC™ Radio-Frequency Identity Protocols Class-1 Generation-2 UHF RFID Protocol for Communications at 860 MHz-960 MHz,” Version 1.0.9 (commonly referred to as Gen-2), and published 2004, which is incorporated by reference herein in its entirety. These terms are provided for use with regards to example embodiments of the invention described further below. It will be appreciated that the meaning of these terms provided below may be modified in embodiments without deviating from the spirit of the invention.

Q—is a parameter that an interrogator provides to tags to control a distribution of tag responses. In a Gen 2 embodiment, Q is an integer in the range of 0 to 15. In an embodiment, an interrogator commands tags in an inventory round to load a Q-bit number into their time slot counter. Typically, each tag independently generates the Q-bit number. The Q-bit number dictates which time slot the tags will respond to an interrogation.

Query—a Query command initiates an inventory round and determines which tags participate in the round. A Query command contains the parameter Q.

QueryAdjust—a QueryAdjust command repeats a previous Query and may increment or decrement Q, but does not introduce new tags into the round. QueryAdjust adjusts Q without changing any other parameters of the round.

QueryRep—a QueryRep command repeats a previous Query command without changing any parameters and without introducing new tags into the round. In a Gen2 context, the QueryRep command instructs tags to decrement the value stored in their slot counters. If the slot counter stores a 0 value after decrementing, the tag backscatters a response to the interrogator. In a Gen 2 embodiment, the tag generates a 16-bit random value, RN16, that it backscatters to the interrogator.

Inventory round—an inventory round is the period between successive Query commands. During an inventory round, an interrogator attempts to interrogate one or more time slots, e.g., using a Query, QueryAdjust, or QueryRep command.

Slot—a “slot” or “time slot” corresponds to a point in an inventory round at which a tag may respond. Tags reply when their slot (e.g. the value in their slot counter) is zero.

Other Terminology

Single response time slot—refers to a time slot in which a single tag responds to an interrogation.

Collided or contended time slots—refers to a time slot in which more then one tag responds to an interrogation, resulting in a collision.

Empty time slot—refers to a time slot in which no tags respond.

In addition, the terms “interrogator” and “reader” are used synonymously herein to refer to a device that communicates with and issues commands to RFID tags.

Example RFID Tag Environment

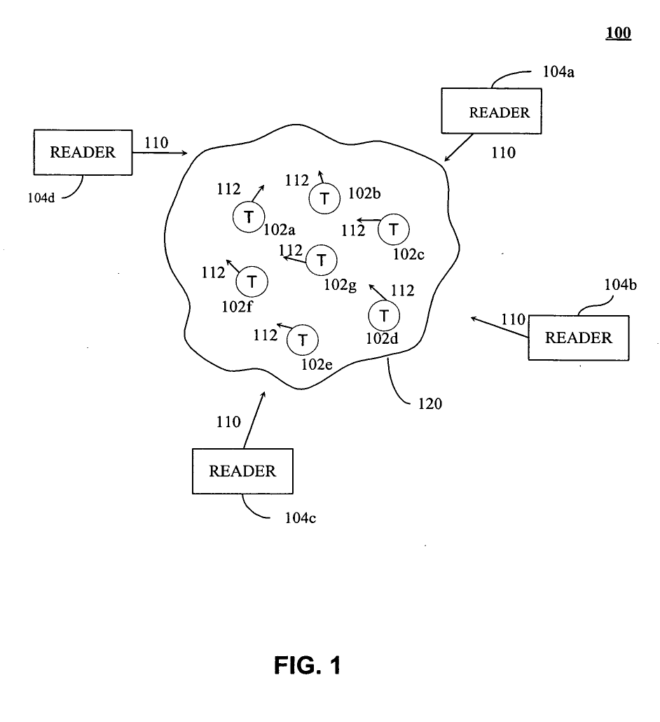

Before describing embodiments of the present invention in detail, it is helpful to describe an example environment in which embodiments of the present invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102. In some embodiments, a very large number of tags 102 (e.g., hundreds, thousands, or even more) may be included in a population 120 of tags.

Environment 100 also includes readers 104a-104d. Readers 104 may operate independently or may be coupled together to form a reader network. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, a reader 104 transmits an interrogation signal 110 having a carrier frequency to the population of tags 120. The reader 104 operates in one or more of the frequency bands allotted for this type of RF communication. For example, frequency bands of 902-928 MHz and 2400-2483.5 MHz have been defined for certain RFID applications by the Federal Communication Commission (FCC). Furthermore, due to regulatory or operational considerations, reader 104 may change carrier frequency on a periodic basis (e.g., ranging from 50 to 400 milliseconds) within the operational band. In these “frequency hopping” systems, the operational band is divided into a plurality of channels. For example, the 902-928 MHz frequency band may be divided into 25 to 50 channels, depending upon the maximum bandwidth defined for each channel. The maximum allowable bandwidth for each channel may be set by local or national regulations. For example, according to FCC Part 15, the maximum allowed bandwidth of a channel in the 902-928 MHz band is 500 kHz. Each channel is approximately centered around a specific frequency, referred to herein as the hopping frequency.

In one embodiment, a frequency hopping reader changes frequencies between hopping frequencies according to a pseudorandom sequence. Each reader 104 typically uses its own pseudorandom sequence. Thus, at any one time, one reader 104a may be using a different carrier frequency than another reader 104b.

Various types of tags 102 transmit one or more response signals 112 to an interrogating reader 104 in a variety of ways, including by alternatively reflecting and absorbing portions of signal 110 according to a time-based pattern or frequency. This technique for alternatively absorbing and reflecting signal 110 is referred to herein as backscatter modulation. Reader 104 receives response signals 112, and obtains data from response signals 112, such as an identification number of the responding tag 102.

There are several manners in which an RFID tag can respond to a reader during an interrogation. A few examples are described below.

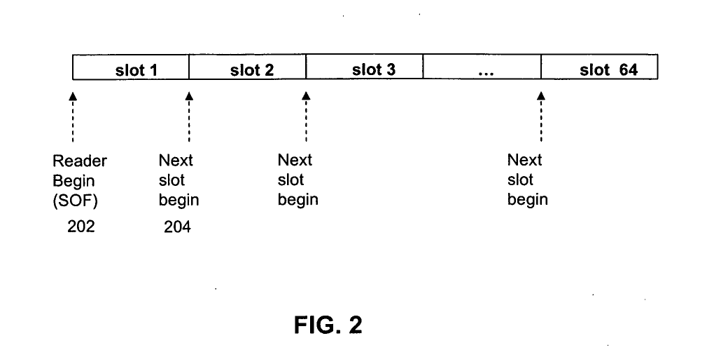

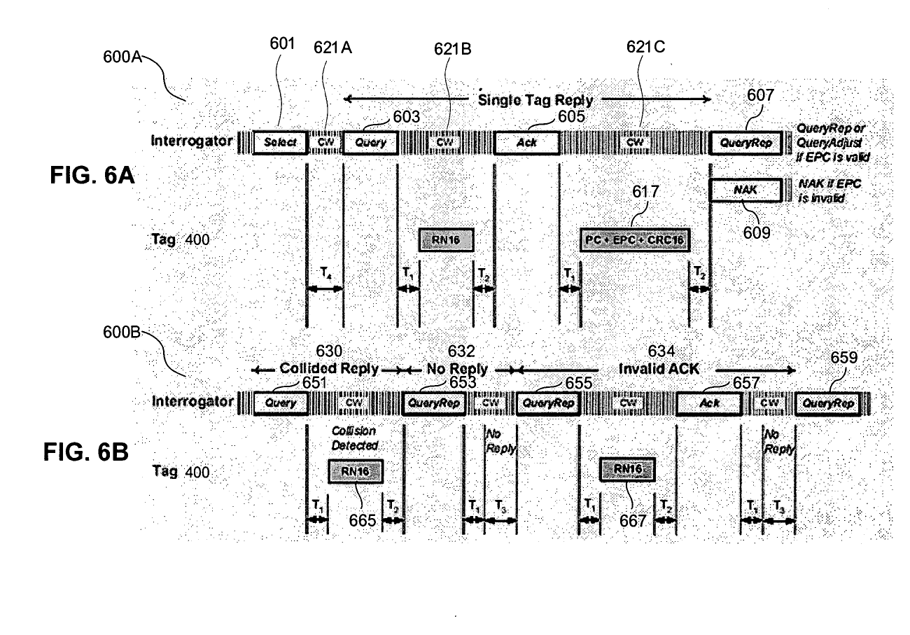

In a RFID environment employing a slotted-ALOHA protocol, FIG. 2 is a timing diagram illustrating a simplified manner in which an RFID tag can respond to an interrogation by an interrogator (reader) in any of 64 time slots (more detailed timing diagrams of tag responses in relation to reader commands are described below with reference to FIGS. 6A and 6B.) As shown in FIG. 2, a reader first sends a reader begin (start of frame (SOF)) signal 202. As described below, tags in a population that receive the reader SOF signal 202 are designated to respond in a particular time slot. Any tags in the population of tags that are designated to respond in slot 1 respond after the signal 202. The reader then sends the next slot begin signal 204, and tags respond that are designated to respond in time slot 2. This process continues for all 64 slots. However, since more than one tag may be designated to respond in any one time slot, tag response collisions can occur which typically destroy communications to the reader and waste time. Similarly, it is also likely that no tags may respond in a particular time slot, also wasting a potential time slot for tag response.

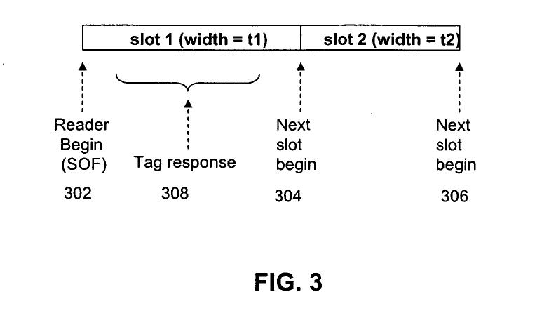

FIG. 3 shows another timing diagram related to a slotted ALOHA type communications protocol. As shown in the example timing diagram of FIG. 3, a reader can shorten a time slot if no tags respond in the time slot. As illustrated in FIG. 3, the reader sends a SOF signal 302, for time slot 1, and receives a tag response 308 in time slot 1. However, the reader sends a second slot begin signal 304 for time slot 2, but does not receive a tag response for time slot 2. As described in more detail below with reference to FIG. 6, the reader may, for example, shorten a time slot if no tag response is received after a predetermined amount of time. Since the reader does not receive a tag response in time slot 2, the reader shortens time slot 2 by sending a next slot signal 306 in a shorter period of time, effectively shortening time slot 2, and causing the next time slot to occur sooner. In this manner, the reader can increase an overall read rate for a tag population, by shortening time slots in which a tag does not respond.

A reader response for a contended or collided time slot is typically handled in a different way. In a collided time slot multiple tags are responding, and the reader will not shorten the time slot as it is attempting to decode received signals. However, time slots that are collided prompt the reader to respond differently to these tags than time slots with a non-collided tag response. For instance, in one example, a reader may specifically acknowledge a correctly received, non-collided tag response while collided tag responses are not acknowledged. Alternatively, a reader may choose to only negatively acknowledge a collided set of tag responses. Furthermore, still in another embodiment, a reader may choose to both acknowledge correctly received tag responses and negatively acknowledge a collided set of tag responses.

In a probabilistic protocol for interrogating RFID tags, the RFID tags each choose a time slot in which to respond to an interrogation. The distribution of time slots chosen by tags in a tag population can be based on statistics. Due to the statistical nature of a probabilistic protocol, there is a probability of three types of transmissions between the RFID tags and the interrogator (reader): (i) a single response time slot where one tag's information is successfully received by a reader, (ii) a contended or collided time slot where multiple tags attempt to transmit their information to the reader, and (iii) an empty time slot where no transmission is made by any tag, i.e., a time slot in which no tags attempt to transmit their information to the reader.

An example probabilistic protocol for implementing communications between RFID tags and an interrogator, commonly referred to as Gen-2, is articulated in “EPC™ Radio-Frequency Identity Protocols Class-1 Generation-2 UHF RFID Protocol for Communications at 860 MHz-960 MHz,” Version 1.0.9, and published 2004, which is incorporated by reference herein in its entirety. In addition, the International Organization for Standardization (ISO) issued two documents, ISO 15693 and ISO 18000, that relate to probabilistic protocols. The entirety of each of these documents is incorporated by reference herein. Embodiments of the present invention are also applicable to further probabilistic protocols than those described herein.

Example RFID Tag

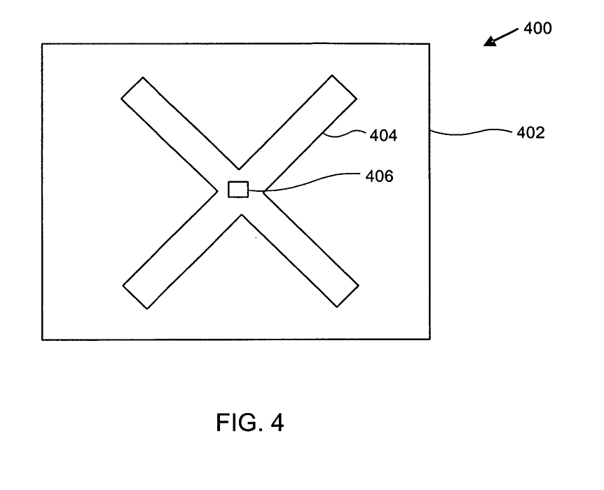

The present invention is applicable to any type of RFID tag. FIG. 4 shows a plan view of an example radio frequency identification (RFID) tag 400. Tag 400 includes a substrate 402, an antenna 404, and an integrated circuit (IC) 406. Antenna 404 is formed on a surface of substrate 402. Antenna 404 may include any number of one or more separate antennas. IC 406 includes one or more integrated circuit chips/dies, and can include other electronic circuitry. IC 406 is attached to substrate 402, and is coupled to antenna 404. IC 406 may be attached to substrate 402 in a recessed and/or non-recessed location. IC 406 controls operation of tag 400, and transmits signals to, and receives signals from RFID readers using antenna 404. Tag 400 may additionally include further elements, including an impedance matching network and/or other circuitry. Tag 400 may also include processor logic. The present invention is applicable to tag 400 (e.g., a semiconductor type tag), and to other types of tags, including surface wave acoustic (SAW) type tags. Additionally, the present invention relates to a protocol method and is applicable to all tag implementations of passive, active, or otherwise power assisted or unassisted types.

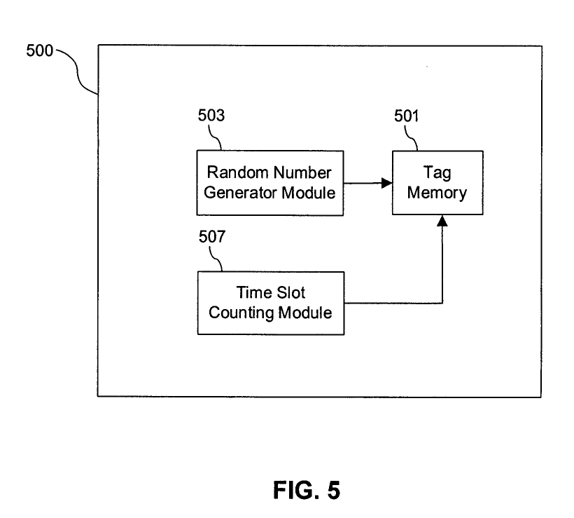

FIG. 5 is a block diagram illustrating processor logic 500 implemented in tag 400 according to an example embodiment of the present invention. Processor logic 500 includes a tag memory 501, a random number generator (RNG) module 503, and a time slot counting module 507. In an embodiment, tag memory 501 can be one of the four tag memories (i.e., reserved memory, unique identifier code (UID) memory, tag identification (TID) memory, or user memory), or a combination thereof, required by the Gen-2 protocol. In addition, in another embodiment, RNG module 503 can be a pseudo-random number generator or a random number generator in accordance with guidelines articulated in the aforementioned candidate specification for RFID tag implementation.

Example Functionality of an RFID Tag

As mentioned above, a probabilistic protocol can lead to single tag response time slots, empty time slots and contended time slots. FIG. 6A illustrates an example timing diagram of a single response time slot. FIG. 6B illustrates an example timing diagram of a contended time slot and an empty time slot. FIGS. 6A and 6B are annotated reproductions of a figure found in the aforementioned candidate specification for RFID tag implementation. The following discussion relates to one example communications protocol, and is provided for illustrative purposes. The present invention is also applicable to alternative communication protocols, as would be understood by persons skilled in the relevant art(s).

Timing diagram 600A of FIG. 6A illustrates timing of a single RFID tag reply to an interrogation from a reader. The interrogation begins in a block 601 in which the interrogator (reader) sends an optional Select command, which selects a particular RFID tag population based on user-defined criteria. The interrogator sends a continuous wave (CW) (e.g. to power tags) 621A for a duration T₄, which is a minimum time between interrogator commands. An inventory round (also referred to herein as an interrogation) of the selected population is initiated by a Query command 603 sent by the interrogator. In response to Query command 603, tags in the selected population randomly choose a time slot in which to respond to the interrogator. An example method by which the tags choose a time slot in which to respond to the interrogator is described below.

If the current time slot is the time slot in which tag 400 is designated to respond, tag 400 responds to Query command 603 after a time T₁ by sending its 16 bit random number RN16. Time T₁ is the time from the interrogator transmission (e.g., Query command 603) to the tag response (e.g., RN16). After a time T₂ (e.g., the time required if a tag is to demodulate the interrogator signal), the interrogator sends an Ack command 605. The interrogator sends Ack command 605 to acknowledge a single tag. After the tag receives Ack command 605, as indicated in tag data block 617, it sends data to the interrogator. For example, the tag may send its protocol control (PC), specific UID known as an electronic product code (EPC), and 16-bit cyclic redundancy check (CRC16) bit patterns. After the tag sends the information in tag data block 617, the interrogator sends a QueryRep command 607 or a Nak command 609. QueryRep command 607 is sent if the EPC is valid, and it instructs other tags in the selected population to decrement their slot counters by one—effectively moving the entire tag population to the next time slot. Nak command 609 is sent if the EPC is invalid.

A method by which the tags choose a time slot in which to respond to the interrogator is now described. The number of time slots available in which to respond to the interrogator may be equal to 2^{Q} e.g., for a 16 time slot configuration, Q is equal to 4, and for a 64 time slot configuration (e.g., as shown in FIG. 2), Q is equal to 6. In accordance with the examples of FIGS. 4 and 5, tag 400 stores the value of Q (which may be initially received from the interrogator) in tag memory 501. RNG module 503 uses the value of Q to randomly generate a 16-bit number (RN16), which is stored in tag memory 501. In one example, tag 400 uses a portion of RN16 (e.g., the four least significant bits for a 16 time slots round) to determine a time slot in which to respond to the interrogator, and masks the remaining numbers. Thus, tag 400 may store the following 16-bit number after this process:
0000000000001011,
   where “000000000000” is the masked portion, and “1011” is the remaining 4-bit random value. Since the binary number 1011 is equal to the decimal number 11, tag 400, in this example, is designated to respond in time slot 12 (when counting time slots from 1). Each time the interrogator broadcasts a next slot signal (e.g., a QueryRep command, as described herein), tag 400 counts down from 12 by using time slot counting module 507 of example processor logic 500 (FIG. 5). When time slot 12 arrives, tag 400 responds to the interrogator.

Based on the above method for choosing a time slot, it is apparent that more than one tag can respond to the interrogator in a single time slot—i.e., a collision can occur. This can happen when more than one tag designates the same time slot for response to the reader. In addition, it may be that no tag responds in a particular time slot, or that a particular response is not received. Timing diagram 600B of FIG. 6B illustrates scenarios for an interrogation by an interrogator in which more than one tag responds (time period 630), no tags respond (time period 632), or a response is invalid (time period 634).

Block diagram 600B begins in a time period 651 in which an interrogator sends a Query command 651, which triggers a tag to respond in the current time slot. However, after a time T₁, more than one tag sends a 16-bit random number, shown as collided RN16 665. Since more than one tag sends an RN16, a collision is detected. Because of the collision, typically no valid tag response is received at collided RN16 655. After a time T₂, the interrogator sends a QueryRep command 653, instructing the tags to decrement their slot counters to move to the next time slot. Due to the collision, no attempt is made at further communications with a tag between Query command 651 and QueryRep 653.

As shown in example timing diagram 600B, after QueryRep command 653, no reply is received during time interval T₃ because there are no tags in the population designated to respond in this time slot. Because no tags respond during time interval T₃, the interrogator issues QueryRep command 655 to move to the next time slot. However, T₃ is shorter than a normal tag response period due to the lack of tag response. In this way, the interrogator shortens this time slot as mentioned above with reference to FIG. 3. The time slot is noticeably shorter than either a collided time slot or a productive time slot.

With regard to time period 634, following QueryRep command 655 and after a time interval T₁, a tag sends a 16-bit random number RN16 667. However, the interrogator issues an invalid Ack command 657. Typically, in a Gen 2 environment, an Ack command includes the RN16 value just received from a tag. However, an Ack command can be invalid, for example, if an incorrect 16-bit random number RN16 is sent with the Ack command. Since Ack command 657 is invalid, no tags respond during time interval T₃. Thus, the interrogator issues another QueryRep command 659 to move to a next time slot.

It is to be appreciated that block diagrams 600A and 600B are provided for illustrative purposes only, and not limitation. For example, a collided reply, no reply, and an invalid Ack are shown sequentially in block diagram 600B; however, it is to be appreciated that these particular types of interrogator-tag events (i.e., a collided reply, no reply, and an invalid Ack) can occur in a typical interrogation round in any order or combination, or not at all.

Example RFID Reader

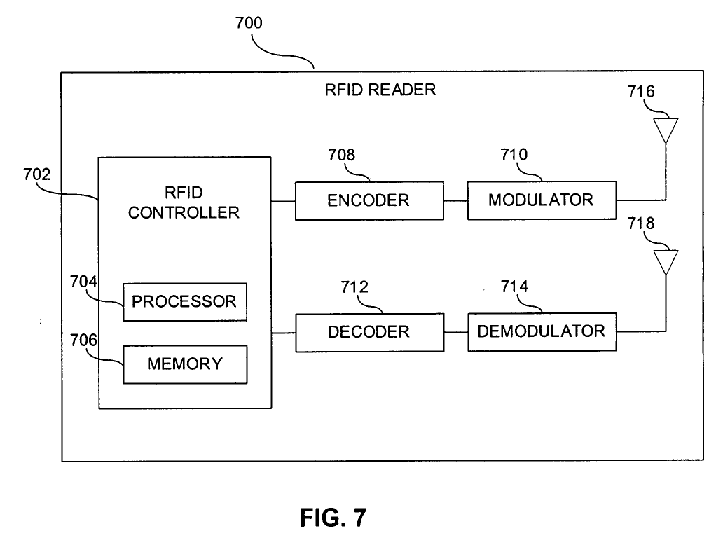

FIG. 7 illustrates an example RFID reader 700 that may be used according to an embodiment of the invention. In this example, RFID reader 700 includes RFID controller 702, processor 704, memory 706, encoder 708, modulator 710, decoder 712, demodulator 714, transmission antenna(e) 716 and receive antenna(e) 718. Although not shown in FIG. 7, an RF front-end may also be included in reader 700.

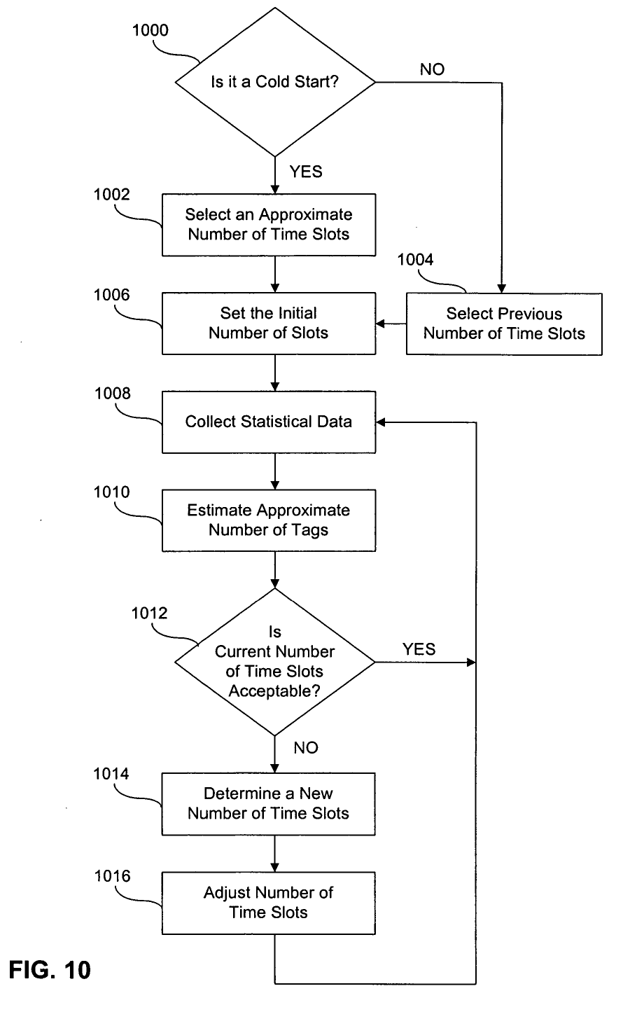

RFID controller 702 provides information, such as interrogations and commands, to tags. The reader information is encoded by encoder 708, modulated by modulator 710 and transmitted by antenna 716. Radio frequency responses are received from a tag population by antenna 718. The tag responses are demodulated by demodulator 714 and decoded by decoder 712. RFID controller 702 processes the decoded responses. In the current embodiment, RFID controller 702 includes a processor 704 and associated memory 706 in addition to any other circuitry required for an RFID reader (not shown). Processor 704 is used to execute instructions and may be a RISC processor, a microcontroller, a digital signal processor (DSP), or a similar instruction processing unit. Processor 704 may have an industry standard instruction set or a proprietary instruction set and may be used to run software or firmware to perform RFID reader functions according to an embodiment of the invention in addition to standard RFID reader functions. For example, processor 704 in conjunction with memory 706 may be used to perform the steps of the flowcharts shown in FIGS. 10-12, described in detail below.

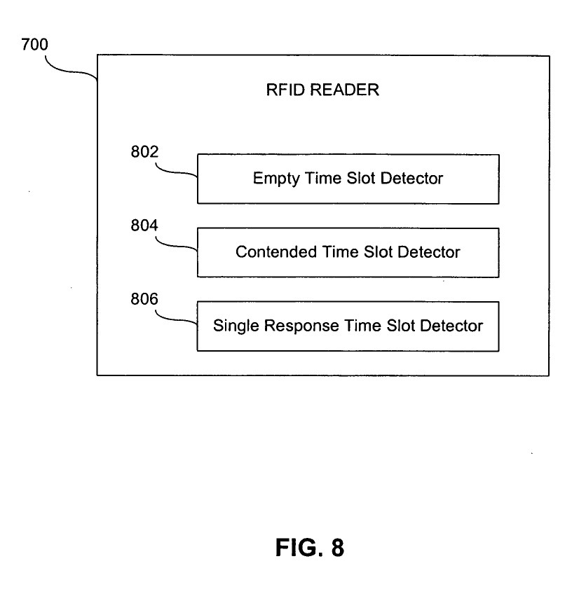

FIG. 8 shows example modules for reader 700, according to an embodiment of the present invention. As shown in FIG. 8, reader 700 may include an empty time slot detector 802, a contended time slot detector 804, and/or a single response time slot detector 806. Empty time slot detector 802 is configured to detect empty time slots, and may additionally keep track of a consecutive number and/or a total number of empty time slots (e.g., during a particular round or other time period). In a similar fashion, contended time slot detector 804 detects collided/contended time slots, and may additionally keep track of a consecutive number and/or a total number of collided time slots. Single response time slot detector 806 detects time slots where a single tag responses, and may additionally detect a consecutive number and/or total number of single response time slots. Example manners in which empty time slot detector 802, contended time slot detector 804, and single response time slot detector 806 perform their respective functions will be apparent to persons skilled in the relevant art(s). For example, modules 802, 804, and 806 may be implemented in hardware, software, firmware, or any combination thereof.

Embodiments for RFID Reader Optimization

As described above, in an embodiment, a reader uses a Query command to instruct the tags choose a response time slot among N possible time slots, wherein N=2^{Q}. The selected time slots may be represented as a counter number on each tag. With each QueryRep command, the tag counters are decremented by one count, or one time slot. Those tags whose counters decrement to zero respond by sending out a 16 bit random number. For time slots where only one tag responds, the tag can be successfully interrogated. Some slots will not be selected by any tag, and they represent an empty time slot where no tag is present to be interrogated. Contended time slots will be selected by more than one tag, and typically none of the contending tags can be successfully interrogated.

The statistics that describe the occupancy probabilities of a particular time slot as described above for a population of M tags are:

$$P ( 0 ) = {( 1 - \frac{1}{N} )}^{M} \qquad Eq . 1$$

where P(0) is the probability of an empty time slot.

$$P ( 1 ) = ( \frac{M}{N} ) * {( 1 - \frac{1}{N} )}^{( M - 1 )} \qquad Eq . 2$$

where P(1) is the probability of a single response time slot.
P(>1)=1−P(0)−P(1) Eq. 3
where P(>1) is the probability of a contended time slot.

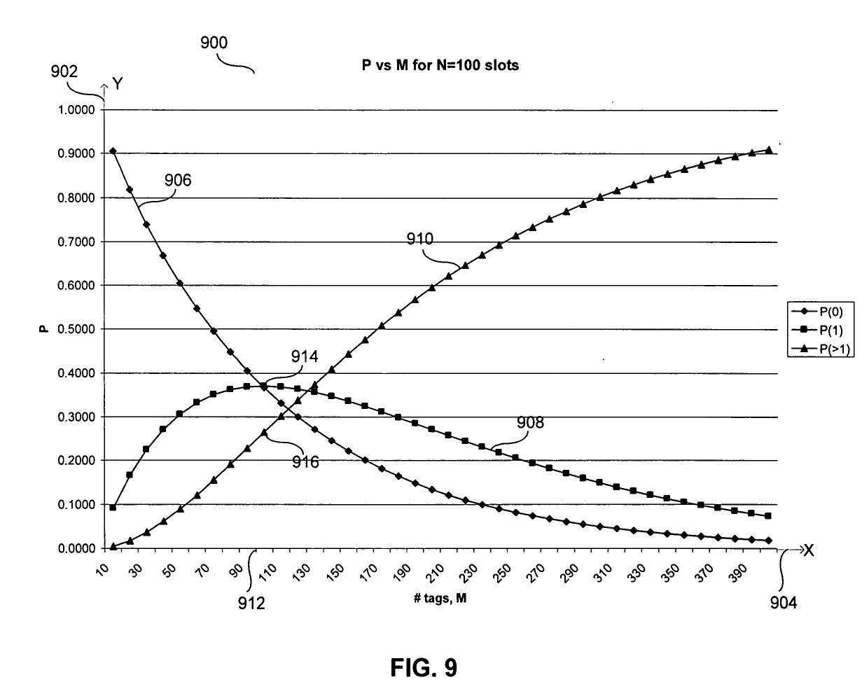

FIG. 9 is a graph 900 of probabilities on a Y-axis 902 vs. a number of tags M on an X-axis 904 for an example fixed number of slots N=100. In graph 900, P(0) is plotted as curve 906, P(1) is plotted as curve 908, and P(>1) is plotted as curve 910. A point 912 on X-axis 904 of graph 900 represents a point where M=N. As shown by graph 900, P(1) curve 908 has a maximum probability of 0.37, at point 914, which is also where M=N. P(0) curve 906 also has a probability 0.37 at point 914, P(>1) curve 910 has a probability of 0.26 at point 916, when M=N.

According to embodiments, optimization of a interrogation occurs with maximization of a probability for P(1). A reader may not know a priori the number M of tags it is interrogating. Embodiments of the present invention enable readers to vary the number of time slots N to optimize an interrogation of the population of M tags.

In order to optimize the value of time slots N, the reader deduces the number of tags M. According to embodiments, this is accomplished by calculating M from at least one of equations 1-3 shown above, using results for P(0), P(1), and P(>1) obtained by attempting one or more interrogations of the tag population.

For example, a reader may select an initial value for N, and provide it to the tags with a Query command. The reader performs one or more queries of the tag population. For example, the reader may initially guess N=100, and may issue ten QueryRep commands. Using the 10 QueryRep commands, the reader may determine that for the respective 10 time slots, there is 1 empty time slot, 3 single response time slots, and 6 contended time slots. From the obtained data, P(0), P(1), and P(>1) can be calculated, as follows:

P(0)=1 empty time slot/10 time slots=0.1,

P(1)=3 single response time slots/10 time slots=0.3, and

P(>1)=6 contended time slots/10 time slots=0.6.

Each of equations 1-3 shown above can be rewritten to determine M, if N, P(0), P(1), and P(>1) are known. For example, from equation 1 above, M is determined to be:

$$M ( 0 ) = \frac{Log ( P ( 0 ) )}{Log ( 1 - \frac{1}{N} )} , \qquad Eq . 4$$

where M(0) is the value of M based on equation 1 for P(0).

From equations 1 and 2 above, M is determined to be:

$$M ( 0 , 1 ) = \frac{( N - 1 ) * P ( 1 )}{P ( 0 )} , \qquad Eq . 5$$

where M(0,1) is the value of M based on both P(0) and P(1).

The following approximate identity can be used to aid in determining M from equation 3:

$${( 1 - \frac{1}{N} )}^{M} = exp ( \frac{- M}{N} ) . \qquad Eq . 6$$

Using the identity of equation 6 in equation 3 above, P(>1) is approximated as:

$$P ( > 1 ) = 1 - ( 1 + \frac{M}{N} ) * exp ( \frac{- M}{N} ) . \qquad Eq . 7$$

From equation 7, M is determined to be:

$$M = \frac{N * ln ( 1 + \frac{M}{N} )}{( 1 - P ( > 1 ) )} \qquad Eq . 8$$

where “In” is the natural logarithm, and where M(>1) is the value of M based on P(>1). M can be determined from any or each of Equations 4, 5, and 8. In particular, because M(>1) is based in part on M, Equation 8 can be iterated to find a value for M(>1) by inputting values for M, with data for P(0), P(1), and P(>1) from one or more interrogations, to generate a new value for M(>1). For example, a first guess for M (e.g., M1) is selected, such as N, or another value. The value used for M1 can be used in equation 8 for M, to find a next value for M, M2. This can be repeated for additional values for M, as needed, until a number of tags in the population is sufficiently converged upon.

For example, M1=N is used in equation 8 to create equation 9, shown below:

$$M 2 = N * ln ( \frac{2}{1 - P ( > 1 )} ) \qquad Eq . 9$$

The value of M2 obtained from equation 9 is again used in equation 8 to obtain a next value for M, M3, as shown in equation 10, below:

$$M 3 = \frac{N * ln ( 1 + \frac{M 2}{N} )}{1 - P ( > 1 )} \qquad Eq . 10$$

Equation 8 may be iterated as desired until a suitable convergence to a final value for M(>1) is obtained. Equation 11 shows a general form of the iteration that may be used to find a final value for M(>1):

$$M ( > 1 ) = M ( p + 1 ) = N * ln ( \frac{( 1 + M ( p ) ) / N}{1 - P ( > 1 )} ) \qquad Eq . 11$$

where p is a positive integer and

$$\frac{M ( p + 1 ) - M ( 0 )}{M ( p )} < \pm delta$$

where “delta” is the desired convergence accuracy. For example, delta may be +/−0.01 (or 1%). Since it may take possibly infinite iterations to find a convergence value for M(>1), “delta” may be used find an acceptable range for convergence accuracy.

In the above example, with 10 QueryRep commands, P(0)=0.1, P(1)=0.3, and P(>1)=0.6. If these values of P(0), P(1) and P(>1) are input into equations 4, 5, and 8, and using N=100 slots and M=100 estimated tags, it is calculated that M(0)=229, M(0,1)=297, and M(>1)=202. Thus, all three estimates for the number of tags in the population M show that N=100 is not a correct value for optimized operation (i.e., if in optimized operation, N=M), and that the reader should likely use a different value for the number of time slots N. In an embodiment, the number of time slots N can be decreased or increased by a factor of 2 (or other factor) if the estimated number of time slots is greater than the initial number of time slots set by the reader (such as in the present example). In such a case, the new value of N will be 100×2=200. The reader may perform another set of interrogations to collect new statistics regarding the new N value, and may further adjust N if required. In embodiments, if the estimated number of tags M is less than the number of time slots N used during an iteration, then the new value of N may be reduced, such as to half the previous value of N. In another embodiment, the new value of N can be set equal to the estimated number of time slots, rather than multiplying (or dividing) N by a factor.

For a selected value of N, the reader performs interrogations of one or more time slots to obtain data and statistics regarding the tag population. Typically, the more time slots that are read the better the data and statistics that are obtained. For example, if just a few time slots are interrogated by a reader, then the subsequent calculated values for P(0), P(1), and P(>1) are typically more approximate, and, thereby, the values for M(0), M(0,1), and M(>1) will likely be different from each other, but should be close in value. The number of time slots interrogated to generate statistics that provide sufficient accuracy vary according to the particular application. This number may be determined by trial and error, or based on the expected population for a given application. The quality of the results typically increases with the number of time slots interrogated. For example, if 21 QueryRep commands were issued, and 3 empty slots, 6 single tag slots, and 12 multiple tag slots were obtained, then P(0)=3/21=0.143, P(1)=6/21=0.286, and P(>1)=12/21=0.571. Inputting these values into equations 4, 5 and 8, obtains M(0)=194, M(0,1)=198, and M(>1)=192. From these M values, the reader may determine that the tag population it is interrogating contains between 192 to 198 tags, and adjust N accordingly.

Once a reader has determined the tag population size and adjusted N to an optimal value or a value within an acceptable range “bandwidth”, it can then keep track of the number of tags it has successfully interrogated and the number of slots it has stepped through. The reader can use this data to continue to optimize an interrogation round. Furthermore, changes to the size of the tag population can be accounted for. In one embodiment, the tag population is decremented by tags successfully read and those tags that are lost due to power fades. In other embodiments, new tags entering and old tags leaving the population are also accounted for. By continuing to monitor the interrogation statistics, a reader will be able to continue to adjust N for changes in tag population, such as tags lost to power fades, and to be able to monitor how many tags are remaining to be read.

After a Query or QueryAdjust command, values are set for M tags and N slots. In embodiments, these are not changed as the reader steps through time slots in a round. However, in some embodiments, N may be varied before the end of an inventory round. As the reader samples more slots the increasing statistical data improves the accuracy of the M prediction. Interrogated tags may not change this result since they do not change the distribution as they are read. Tags that drop out (such as due to power fades) may change the tag population statistical distribution as an interrogation proceeds. The reader may detect tags lost by periodically redetermining M, and monitoring a decrease in the determined values of M, while accounting for the tags already read.

A reader can account for tags read and tag dropouts. A reader may accomplish this at each time slot step by decrementing tags read from the previous value of calculated M and by decrementing N by the number of slots the reader has stepped through. Then the statistics at each time slot are calculated by using “Mrem” and “Nrem”:
Mrem=M−Mread
where Mrem is the calculated value of remaining tags to be read. Mread is the number of tags read, and
Nrem=N−Nsteps
where Nrem is the remaining number of slots to step through. Nstep are the number of slots the reader has interrogated up to the current slot.

For best results, the reader will continue to gather statistics to continue to improve the calculated value of M for N slots, as well as calculate the predicted value for Mrem, which alerts the reader as to when it is closing in on the end of the tag population during interrogation, as well as assist in adjusting N for tag drop outs due to power fades and new tags entering the population.

In an embodiment, for calculating M values, the reader calculates values for at least two of P(0), P(1) or P(>1). In other words, a non-zero value must be obtained for at least 2 of the 3 probabilities for an M value to be calculated. M(O,1) can be calculated when there are data points for both P(0) and P(1). However, in alternative embodiments, calculating values for at least one of P(0), P(1) or P(>1) may be sufficient to estimate M.

If desired, a calculated N value for a round can be used in future rounds. For example, once a value of M has been calculated during an interrogation, this value can be used by the reader as the N value in a Query command of a new inventory round. In some environments, it can be expected that the tag population would not be radically different between inventory rounds in some environments. Alternatively, a new N value can be calculated for each round.

Optimization Bandwidth

Embodiments of the invention employ an “optimization bandwidth” which is an acceptable range of values for the number of slots N. For example, as shown in FIG. 9, the peak value of P(1) is 0.37, at point 914, where M=N=100. Furthermore, the value of P(1) is at or above 0.35 for values of M between 70 to 140, and is near or above 0.3 for values of M from 50 to 200. So, for a value of N=100, calculated values of M from 70 to 140 may describe a preferred range of operation in an embodiment, while calculated values of M from 50 to 200 may describe an acceptable range of operation in another embodiment. Other ranges are also applicable to embodiments.

In an embodiment, calculated ranges of M<50 or M>200 describe actionable numbers requiring a new QueryAdjust command to be issued to change the value of N to a new value. A broad bandwidth of acceptable operation accommodates a very simple adjustment algorithm for N, which is to adjust by either multiplying or dividing by a factor of 2 (or other value(s)) without overcompensating or requiring re-compensating. It will be appreciated that optimization bandwidth examples presented above are design parameters that can be varied as required. For example, for N=100, if M is determined to be near 200, N would be increased by a factor of 2, putting the interrogation near or at maximum efficiency. If the real value of M is 100, and the calculated value is 200, increasing N by a factor of 2 would still put the operation at the edge of acceptable operation. If the real value of M is 400, and the calculated value is 200, increasing N by a factor of 2 from 100 puts operation on the right correction path. Continued statistics to refine the calculated value of M lead to further corrections for optimized operation.

Embodiments of the invention attempt to achieve optimized operation with as few data points as possible and thereby maximize efficiency. If a few data points yield a calculated value of M=200 with N=100, then a reader may obtain further data points to refine the statistics before adjusting to a more optimal value of N. The additional data may yield a calculated value of M=130, which is in the desired range of operation, or it might yield M=210, requiring an increase of N by a factor of 2.

Cold Starts

A “cold start” refers to when a reader first issues a Query command for a new tag population with no previous history of population size. A reader may choose, for example, a predetermined number of tags or a number of tags based on the application at hand. A reader's first guess for N may be far off an optimum value for N, such as N=M, and it may see only empty slots or contended tag slots, where no statistics can be obtained.

On cold starts it is desired to find an acceptable value for N as soon as possible, so that the tag population can be quickly and effectively read. Thus, it is desirable to step through as few empty or multiple tag slots as possible before using a QueryAdjust command. For example, if three time slots are examined, having a single response time slot followed two empty time slots, then the reader can calculate P(0)=0.67, P(1)=0.33, and P(>1)=0. Accordingly, M(0)=40 and M(0,1)=50, for an initial guess of N=100. An initial guess of 50 tags is within an acceptable bandwidth, so adjusting after two empty slots may be premature, particularly with P(0)>0.3, which may indicate that the reader is in the range of acceptable operation. In this case, the reader may continue issuing QueryRep commands and use the additional accumulated statistics for subsequent optimization.

In another example of a cold start, a string of three empty slots may be followed by a single response time slot. In this example, P(0)=0.75, P(1)=0.25, and P(>1)=0, for which M(0)=29 and M(0,1)=33 for N=100. These values of M may be outside an acceptable bandwidth and the reader may issue a QueryAdjust command for a new value of N=50 instead of waiting to collect more data samples. Therefore, in this case the reader may be configured to decrease the number of slots by a factor of 2 on receiving three empty slots on a cold start. Assuming that after this adjustment, the reader receives another string of empty slots, such as three empty slots, it could further decrease the value of N by a factor of 2. This process may be repeated until a preferred optimization bandwidth or range of operation is reached. Note that adjustment factors other than 2 may be alternatively used.

In embodiments, an initial guess for N upon a cold start could be application dependent. For example, in an application where a reader would normally expect to see only a few tags, a low value for N, such as 4, may be initially used, which may optimally accommodate 2 to 8 tags, or a value of 8, which may optimally accommodate 4 to 16 tags. If the reader would normally expect to see several hundreds of tags, it could start with a value of N=100, which may optimally accommodate 50 to 200 tags. It will be appreciated that the above examples of initial number of slots used in a cold start are by way of example only and may vary by design.

In another example, on a cold start a reader may receive a string of contended time slots. For example, a reader may receive two contended time slots followed by a single response time slot. These three time slots, the statistics yield probabilities P(0)=0, P(1)=0.33, and P(>1)=0.67. For these probabilities, M(>1)=228 for N=100, which is just outside the optimization bandwidth. For the same probabilities, P(1)>0.3, which is inside the optimization bandwidth. In this example, for a particular configuration, it may be premature to adjust the value of N. However, a string of three contended time slots followed by a single response time slot yields P(0)=0, P(1)=0.25, and P(>1)=0.75, for which M(>1)=269, which combined with a P(1)<0.3 is outside the optimization bandwidth, requiring a slot adjustment by increasing N by a factor of two. Therefore, in this example, on a cold start it may be appropriate for the reader to increase the number of time slots by a factor of 2 on receiving three contended time slots after a cold start. If after adjusting N, the reader receives another string of three contended time slots, it may further increase N by a factor of 2. The reader may continue this process until optimal or acceptable operation is achieved. Again, the number of time slots to increment or decrement and the optimization bandwidth vary by the requirements of the particular application.

Using a bandwidth for N within which acceptable operation is obtained makes the above approach less vulnerable to errors caused by statistical variation inherent in a few data points. It is statistically possible, but with low probability, to receive a string of three empty time slots or contended time slots, and still be in the acceptable range of operation. For those occurrences, adjustment of N would put the reader on the other boundary edge of acceptable operation. Further data points would yield increasingly better statistical results for subsequent optimization if required.

After a cold start, a reader accumulates statistical data allowing it to optimize operation within a high degree of certainty. In embodiments, the overall statistics gathered after a cold start guide the operation as opposed to strings of empty or contended time slots. During a QueryRep command, a change in the tag population may occur because of tag dropouts, such as due to power fades. It is possible that this could have a significant impact on the tag population, causing the reader to see more empty slots than would be expected. The reader may employ a simple heuristic to accommodate this situation, by decreasing N by a factor of 2 when it saw a string of four or five empty slots. The impact of a wrong decision depends on which side of the acceptable operating regime the reader was operating in, the high number of tags side or the low number of tags side. If it was on the high tag side, and the string of empty slots was a statistical aberration, then decreasing N by a factor of 2 will send the reader operation outside the optimization bandwidth, and it will have to recover. However, if it was on the low tag side, it would send the reader to the high tag side of the optimum bandwidth. So an improved approach is for the reader to calculate with the accumulated statistics the probability of a string of empty slots based on where in the acceptable optimization bandwidth it is positioned. For example, for N=100 and M=140, which may be the higher side of optimization bandwidth, the probability for an empty slot is P(0)=0.245. The probability for a string of “n” empty slots is P(0,n)=0.245n. If M=70, which may be the lower side of acceptable optimization bandwidth, then P(0)=0.5, which is twice as likely to occur compared to P(0)=0.245. P(0,n)=0.5n. The reader may decide to decrease N by a factor of 2 once the calculated probability, P(0,n) of a string of empty slots is less than some pre-determined limit, such as 0.05. For M=140, this would occur at n=3 empty slots. For M=70, this would occur at n=5 empty slots.

Another embodiment is for the reader to use a “sliding window” for accumulating statistics which would move as the reader steps through the slots. The sliding window is set to a fixed number of slots wide. The slot width is predetermined and in embodiments may be wide enough to accumulate reasonably robust statistics, but narrow enough for tag drop out to be statistically determined in a minimum number of slot steps. For example, a width of 11 slots for a sliding window may be enough to monitor optimum statistics where optimally there would be 4 empty slots expected in that window. An increase of one empty slot would affect the statistics enough for the reader to start detecting a decrease in the number of tags, M. An increase of two empty slots would be enough for the reader to determine a decreased tag population that falls outside the optimization bandwidth. The reader may decrease N by a factor of 2 to accommodate. In a sliding window embodiment, the empty slots do not have to consecutively enter the window. The total number of empty slots in the window, along with the single and multiple tag slots in the window, is used. This approach has the merit of reacting more quickly to tag dropouts and accommodating to maintain optimum operation. With fewer data points, it may be subject to statistical fluctuations. This problem could be minimized by not acting on a single window of data, but instead gathering statistics for multiple windows. The reader may calculate the value of M for each window and store the result. The reader may average the data over multiple windows. If tag drop out is occurring, the reader may see a record of decreasing M in the windows as it steps through the slots until M dropped below the boundary of an optimization bandwidth. The reader may decrease N by a factor of 2 to accommodate. Similarly in the case of new tags entering the population, the reader may increase N by a factor of 2.

It will be appreciated that there are other ways than calculating probabilities of inferring M for a value of N such as using curve fitting to the data. This will be understood by person(s) skilled in the relevant art(s) from the teachings herein.

FIG. 10 is an example flowchart, providing steps for determining an acceptable value of time slots to use in an inventory round, according to an embodiment of the invention. The steps in the flowchart may be performed by a reader in hardware, software, firmware or any combination thereof, including being performed by the readers described above.

In step 1000, before starting an inventory round, a reader determines if it is a cold start. If it is a cold start, operation proceeds to step 1002. If it is not a cold start, operation proceeds to step 1004.

In step 1002, the reader selects an approximate number of time slots. This number may be determined on the fly, pre-programmed, or hardwired in the reader. In embodiments, the reader may choose an initial number of time slots based on the current application or based on the operation environment.

In step 1004, the reader may choose a previous number of time slots to be used as the initial number of time slots, such as was used in a previous inventory round.

In step 1006, the reader sets the number of time slots in an inventory round using the numbers determined in either of steps 1002 or 1004. In a Gen-2 or similar environment, the reader may transmit a Query command to the tag population. This sets the initial number of time slots by setting a value for the integer Q in the tag population as described above.

In step 1008, the reader collects statistical data by interrogating and monitoring responses of the tag population. As described above, the reader may interrogate and monitor a predetermined number of time slots, including monitoring a series of time slots, using a sliding window, etc., to count a number of empty, contended or single response time slots across a set of time slots.

In step 1010, the reader estimates the number of tags in the population based on statistics obtained in step 1008. In embodiments, it may do this by using probabilities as described above. For example, equations 4, 5 and 8.

In step 1012, the reader determines if the number of time slots set in step 1006 is optimal or within the acceptable optimization bandwidth as described above. In one embodiment, the optimal value for the number of time slots is a value equal to the number of estimated tags. In another embodiment, an acceptable number of time slots is a value within an acceptable range or bandwidth for time slots.

If the number of time slots is optimal or within an acceptable optimization bandwidth, then the reader returns to step 1008 and continues to monitor the tag responses and collect statistical data.

In step 1014, if the number of time slots is not acceptable, the reader determines a new number of time slots based on the estimated number of tags. In one embodiment, the new number of time slots is equal to the estimated number of tags. In another embodiment, the new number is equal to the previous value multiplied by a factor such as 2 or 0.5.

In step 1016, the reader adjusts the number of time slots based on the estimated number of time slots determined in step 1014. In a Gen-2 or similar environment, the reader transmits a QueryAdjust command to the tags to set the number of slots, which is indicated by a value for the integer Q discussed above. The reader may change the number of slots during an inventory round by using the QueryAdjust command or at the start of an inventory round by using the Query command.

After completing step 1016, the reader returns to step 1008 and continues to collect statistical data by monitoring time slots for tag responses, estimating the number of tag in step 1010 and determining if the number of time slots is optimal or within an acceptable range in step 1012.

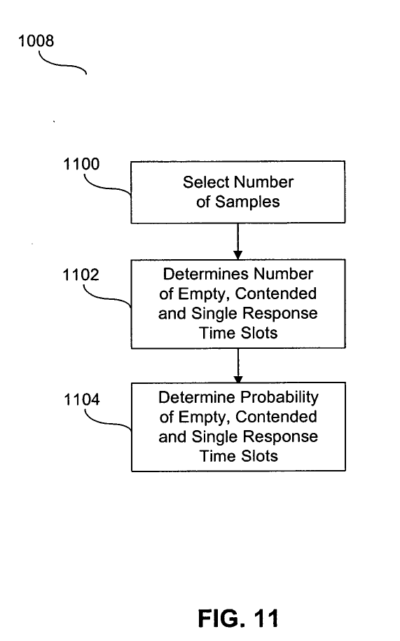

FIG. 11 is an example flowchart showing steps taken by the reader to collect statistical data according to an embodiment of the invention. For example, the steps in the flowchart shown in FIG. 11 may be performed in step 1008 of the flowchart in FIG. 10.

In step 1100, the reader selects a number of time slot samples to monitor. This number may be based on prior empirical results may be a predetermined value or may be based on the application or operational environment.

In step 1102, the reader collects statistical data by counting the number of empty time slots, contended time slots and single tag response time slots for the number of time slots determined in step 1100.

In step 1104, using the data collected in step 1102, the reader determines the probability of an empty, contended, and/or single response time slot as described above. For example, dividing the numbers of empty, contended, and single tag response time slots by the total number of times slots can be used to determine the probabilities of an empty, single or contended time slot, respectively.

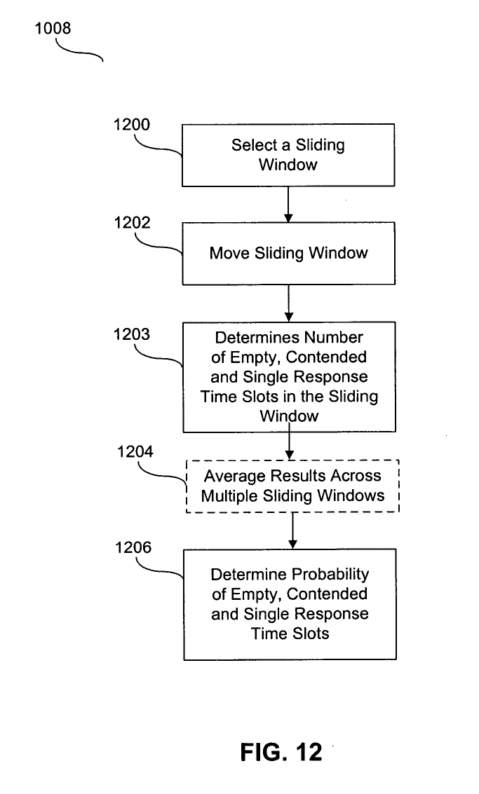

As described above, a sliding window approach may be used to monitor time slots to determine an appropriate number of time slots N. FIG. 12 is an example flowchart of the steps taken by the reader to collect statistical data using a sliding window according to another embodiment of the invention. For example, the steps in the flowchart shown in FIG. 12 may be performed in step 1008 of the flowchart in FIG. 10.

In step 1200, the reader selects the size of sliding window. For example, the size can be based on prior empirical data, on a predetermined number, application, environment or another source.

In step 1202, the reader moves the sliding window with the increase in number of time slots. The number of slots the reader moves the window by is based on configuration and may vary in embodiments.

In step 1203, the reader monitors the number of time slots that are empty, contended or single response time slots in the sliding winding.

In optional step 1204, the reader may average the statistical data collected by multiple windows. Thus, step 1203 may be repeated prior to step 1203. It will be appreciated that the reader may use other statistical measures such as mean squared or root mean squared to calibrate results over multiple windows.

In step 1206, the reader determines the probability of an empty, contended or single response time slot as discussed above.

It should be understood that elements of the systems described herein can be implemented in hardware, firmware, software, or a combination thereof. For example, hardware, firmware, and/or software modules can perform one or more of the illustrated components of FIG. 7 (e.g. processor 704) and/or steps shown in the flowchart of FIG. 10. For example, the hardware, firmware, software, or any combination thereof, may include algorithms for the control of reader 700.

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a computer executes computer-readable instructions to control one or more of a RFID reader functions. For instance, a computer may set an initial number of time slots, monitor tag responses for a predetermined number of slots, collect statistical data based on the tag responses, estimate a number of tags in the population and adjust the number of time slots accordingly. Tags may be communicated with by the reader according to any suitable communication protocols, including binary traversal protocols, slotted aloha protocols, Class 0, Class 1, EPC Gen 2, those mentioned elsewhere herein, and future protocols.

An RFID reader can collect statistical data of the interrogation from monitoring tag responses in a number of ways. For example, based on the tag responses, the reader can count (i) a number of empty time slots, (ii) a number of contended time slots (iii) a number of single response time slots and/or any permutation or combination of items (i), (ii) and (iii). The actual manner in which the reader counts the slots of (i), (ii) and (iii) is dependent on the particular protocol. For illustrative purposes, examples are described in terms of Gen-2; however, it is to be appreciated that other probabilistic protocols can be used.

For each of items (i), (ii), and (iii), the reader can count a total or a consecutive number of time slots. Examples with respect to item (i) are described below to illustrate this point. Similar examples for items (ii) and (iii) will be apparent to a person skilled in the relevant art(s) from the description contained herein.

As a first example, the reader can count the total number of empty time slots in an interrogation, by using, for example, empty time slot detector 802 of FIG. 8. The reader can compare the total number of empty time slots in the interrogation, to the total number of time slots in the interrogation, to determine the probability of an empty time slot. Based on this probability, the reader can adjust the number of time slots. If the probability is less than a threshold (e.g., 0.3), the reader may decide to decrease the number of time slots; whereas if the probability is greater than a threshold (e.g., 0.3), the reader may decide to increase the number of time slots.

As a second example, the reader can count a consecutive number of empty time slots by using, for example, empty time slot detector 802. An example method by which empty time slot detector 802 counts a successive number of empty time slots can be implemented as follows:
An empty time slot accumulator is set to an initial value (e.g., 4).
If an empty time slot is detected, empty time slot detector 802 decrements the value stored in an empty time slot accumulator.
If a non-empty time slot is detected, the empty time slot detector 802 increments the value stored in the empty time slot accumulator.
If the accumulator reaches a minimum value (e.g., 0), the reader determines a new number of time slots as described above. The reader may reset the accumulator to the initial value.
If the accumulator reaches a maximum value (e.g., 8), the reader can then determine a new number of time slots as described above. Then, reset the accumulator to the initial value.
Example Advantages

Embodiments of the present invention provide several example advantages, including those described above. For example, RFID tag interrogations performed in accordance with an embodiment of the present invention (i) lessen the number of empty and contended time slots, and (ii) increase the number of single response time slots. In this way, embodiments of the present invention provide for efficient interrogations of RFID tag populations.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a radio frequency identification (RFID) reader to adjust a number of time slots in an inventory round for interrogating a population of tags, comprising:
setting a first number of time slots in a tag inventory round;
monitoring time slots for responses from tags to obtain statistical data based on the responses;
estimating a number of tags in the population based on the statistical data; and
setting a second number of time slots in a round based on the estimated number of tags.

2. The method of claim 1, wherein said monitoring further comprises counting a total number of empty time slots, a total number of contended time slots and a total number of single response time slots for a predetermined number of time slots.

3. The method of claim 1, wherein estimating a number of tags further comprises determining at least one of a probability of an empty time slot, a probability of a contended time slot and a probability of a single response time slot.

4. The method of claim 1, wherein said monitoring is performed for a predetermined number of time slots.

5. The method of claim 1, wherein the second number of time slots is set equal to the estimated number of tags.

6. The method of claim 1, wherein the second number of time slots is set to twice the first number of time slots if the estimated number of tags is greater than the first number of time slots.

7. The method of claim 1, wherein the second number of time slots is set to half the first number of time slots if the estimated number of tags is lesser than the first number of time slots.

8. The method of claim 1, further comprising transmitting a Query command prior to said monitoring.

9. The method of claim 8, wherein said monitoring further comprises transmitting a QueryRep command.

10. The method of claim 8, wherein said setting a second number comprises transmitting a QueryAdjust command.

11. A radio frequency identification (RFID) reader device, comprising:
a RFID controller;
a transceiver coupled to the RFID controller;
at least one RF antenna coupled to the transceiver;
wherein the RF antenna transmits commands received from the RFID controller via the transceiver and receives responses from a population of RFID tags in an environment; and
wherein the RFID controller is configured to set a first number of time slots in a tag inventory round, monitor time slots for tag responses to collect statistical RFID tag response data, estimate a number of tags in the environment based on the statistical RFID tag response data, and set a second number of time slots in a round based on the estimated number of tags.

12. The reader device of claim 11, wherein the RFID controller is configured to monitor a predetermined number of time slots for a total number of empty time slots, a total number of contended time slots and a total number of single response time slots.

13. The reader device of claim 11, wherein the RFID controller determines at least one of a probability of an empty time slot, a probability of a contended time slot, and a probability of a single response time slot.

14. The reader device of claim 11, wherein the tag response data is collected for a predetermined number of tags.

15. The reader device of claim 11, wherein the RFID controller sets the second number of time slots equal to the estimated number of tags.

16. The reader device of claim 11, wherein the RFID controller sets the second number of time slots to twice the first number of time slots if the estimated number of tags is greater than the first number of time slots.

17. The reader device of claim 11, wherein the RFID controller sets the second number of time slots to half the first number of time slots if the estimated number of tags is lesser than the first number of time slots.

18. The reader device of claim 11, wherein the RFID controller generates a Query command transmitted by the at least one RF antenna.

19. The reader device of claim 11, wherein the RFID controller generates a QueryRep command transmitted by the at least one antenna.

20. The reader device of claim 11, wherein the RFID controller generates a QueryAdjust command transmitted by the at least one antenna.
